(19) United States
(12) Patent Application Publication
(10) Pub. No.: US 2010/0006178 A1
(43) Pub. Date: Jan. 14, 2010

(54) Incorrect-Refueling Arrangement

(76) Inventors: Joachim Muth, Plettenberg (DE); Rene Körber, Leutenbach (DE)

Correspondence Address: BACON & THOMAS, PLLC, 625 SLATERS LANE, FOURTH FLOOR, ALEXANDRIA, VA, 22314-1176, US

(21) Appl. No.: 11/989,517

(22) PCT Filed: Jul. 27, 2006
(86) PCT No.: PCT/EP2006/007424

§ 371 Date: Sep. 8, 2009

(30) Foreign Application Priority Data
Jul. 27, 2005 (DE) 20 2005 012 256.4

(51) Int. Cl. B60K 15/04

(52) U.S. Cl. 141/350; 220/86.2

(57) ABSTRACT

A purely mechanically operating incorrect-refueling device for a filler tube of a tank has a receiving element, which can be pressed apart radially from its interior space at least on opposite wall areas, and a flap, which is arranged on the output side of the receiving element, covers the receiving element in locking fashion in the resting state, and is unlocked and can be opened under pressure when the receiving element is pressed apart.

The present invention relates to an incorrect-refueling arrangement for a filler tube of a tank.

Various incorrect-refueling systems are known that use sensors in very different ways. For example, it is known to provide the filler tube with a permanent magnet and the pump nozzle with a sensor, which releases an inflow valve when it comes in contact with the magnetic field of the permanent magnet. In another incorrect-refueling system, in order to prevent the refueling of a diesel vehicle with gasoline, the filler tube is provided with ultrasound sensors that measure the diameter of the inserted pump nozzle and, if necessary, emit a warning signal or trigger the activation of the inflow valve. In yet another incorrect-refueling system, the front end of the pump nozzle is provided with a magnet ring, and the filler tube is mounted with a magnet sensor that via an evaluation unit influences a signal transmitter or the through-flow valve.

All of these known incorrect-refueling systems require external power to activate the sensor systems.

The objective of the present invention is to provide for a filler tube of a tank an incorrect-refueling device which operates on a purely mechanical basis.

To achieve this objective in an incorrect-refueling device for a filler tube of a tank, the features indicated in Claim 1 are provided.

The measures according to the present invention indicate an incorrect-refueling device that functions in a purely mechanical fashion. The principle of this incorrect-refueling device is based on the fact that, for example, pump nozzles for gasoline have a smaller tubular diameter than pump nozzles for diesel fuel. This means that the components of the receiving element for the pump nozzle are only forced apart and the filling of the tank only permitted if the larger-diameter pump nozzle for diesel fuel is inserted into the receiving element. If a pump nozzle for gasoline is inserted, the incorrect-refueling device remains in its locked initial position.

According to one preferred embodiment, the features accorded to Claim 2 are provided in order to achieve a consistent pressing apart of the receiving element in response to the insertion of a tube having the diameter in question. In accordance with the features of Claim 3, the receiving element expediently has a specific cross-section.

The receiving element can be designed either in accordance with the features according to Claim 4, so as able to be elastically pressed apart, or it can be formed in an advantageous manner in accordance with the features of Claim 5, through individual and individually hinged circumferential wall parts that are distributed over the circumference. In this way, a locking of the flap is accomplished in a simple manner.

Advantageous embodiments of the circumferential wall parts and their type of hinge design can be seen from the features of one or more of Claims 6 to 8.

Various safety devices to guard against manipulation can be seen from the features of one or more of Claims 9 to 12.

The features according to Claim 13 indicate a simple design of the flap hinge and lock.

Advantageous designs of the flap can be seen from the features of one or more of Claims 14 to 18. On the basis of the features according to Claim 19, an incorrect operation or manipulation, whether intentional or unintentional, is avoided. The same applies to embodiments according to the features of Claims 20 and 21, since as a result the receiving element can evade manipulation in a certain way.

The present invention also relates to a filler tube for a tank in accordance with the features of Claim 22 and the features of Claim 23 and/or 26 and/or 25.

Furthermore, the present invention also relates to a liquid tank having a filler tube in accordance with Claim 22 and one or more of the following claims.

Finally, the present invention relates to an incorrect-refueling system having an incorrect-refueling device in accordance with Claim 1 and at least one of Claims 2 to 21, and having a pump nozzle as characterized in Claim 27.

Further details of the invention can be derived from the following description in which the invention is described and explained in greater detail on the basis of the exemplary embodiments depicted in the drawing.

In the drawing:

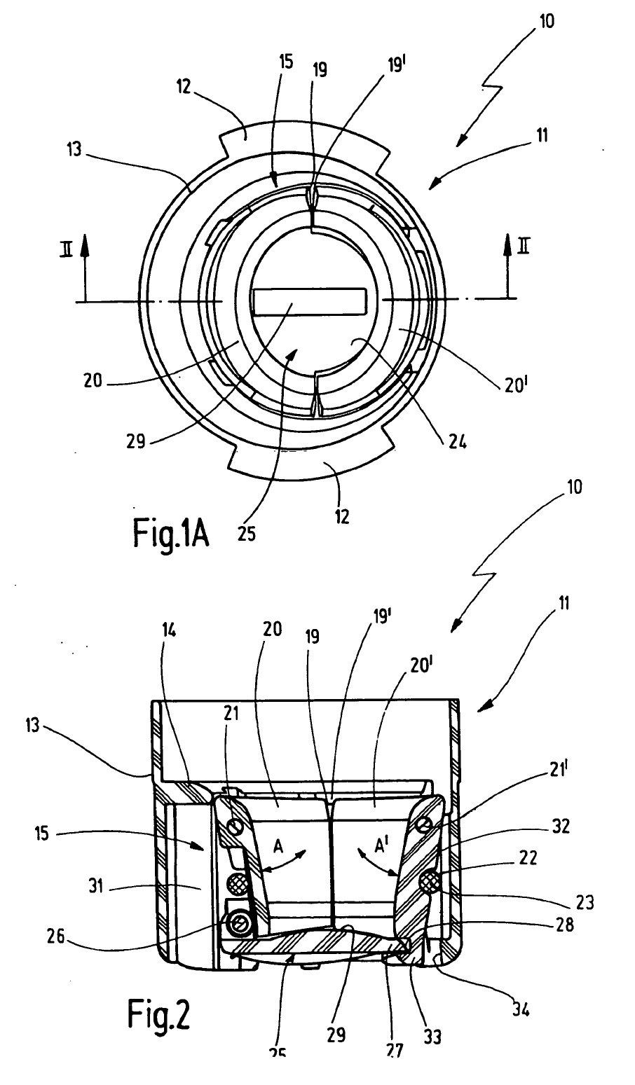

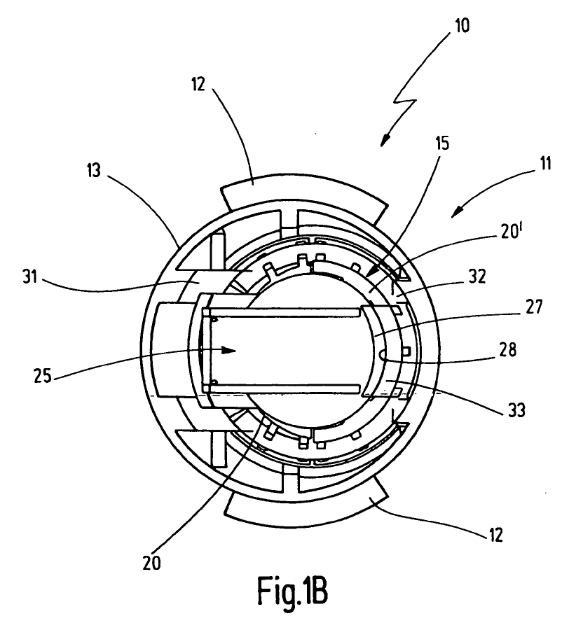

FIGS. 1A and 1B in a top view and bottom view, depict an incorrect-refueling device for a tank filler tube in accordance with a first exemplary embodiment of the present invention,

FIG. 2 depicts a cutaway view along the line II-II of FIG. 1A,

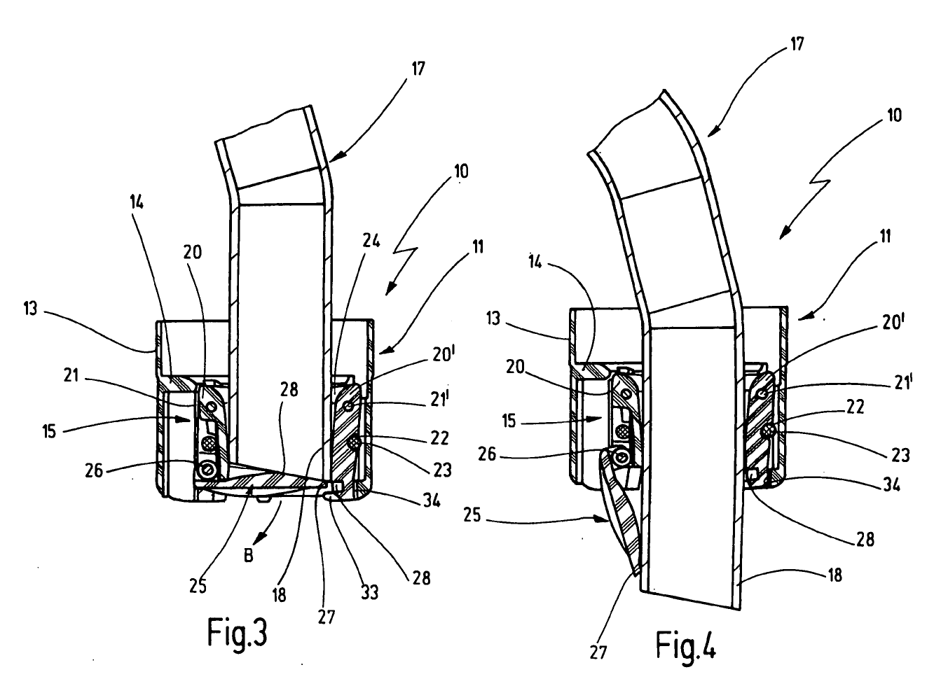

FIG. 3 depicts a representation corresponding to FIG. 2, but in a condition of the incorrect-refueling device that is unlocked by a pump nozzle,

FIG. 4 depicts a representation corresponding to FIG. 3 after the penetration of the incorrect-refueling device by a pump nozzle,

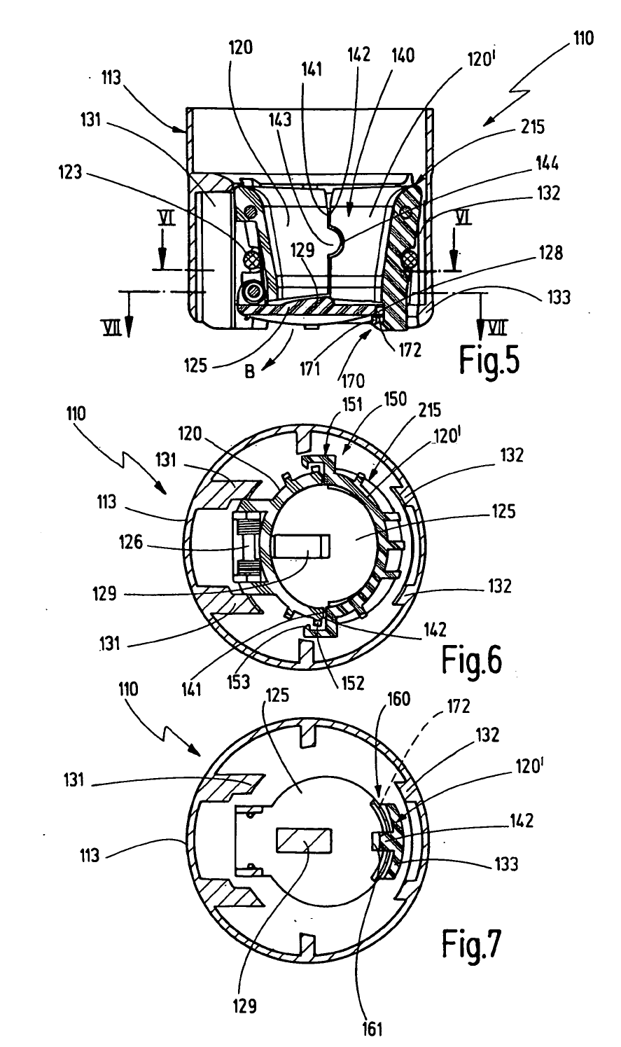

FIG. 5 depicts a representation corresponding to FIG. 2 of an incorrect-refueling device for a tank filler tube according to a second exemplary embodiment of the present invention,

FIG. 6 depicts a cutaway view along the line VI-VI of FIG. 5,

FIG. 7 depicts a cutaway view along the line VII-VII of FIG. 5,

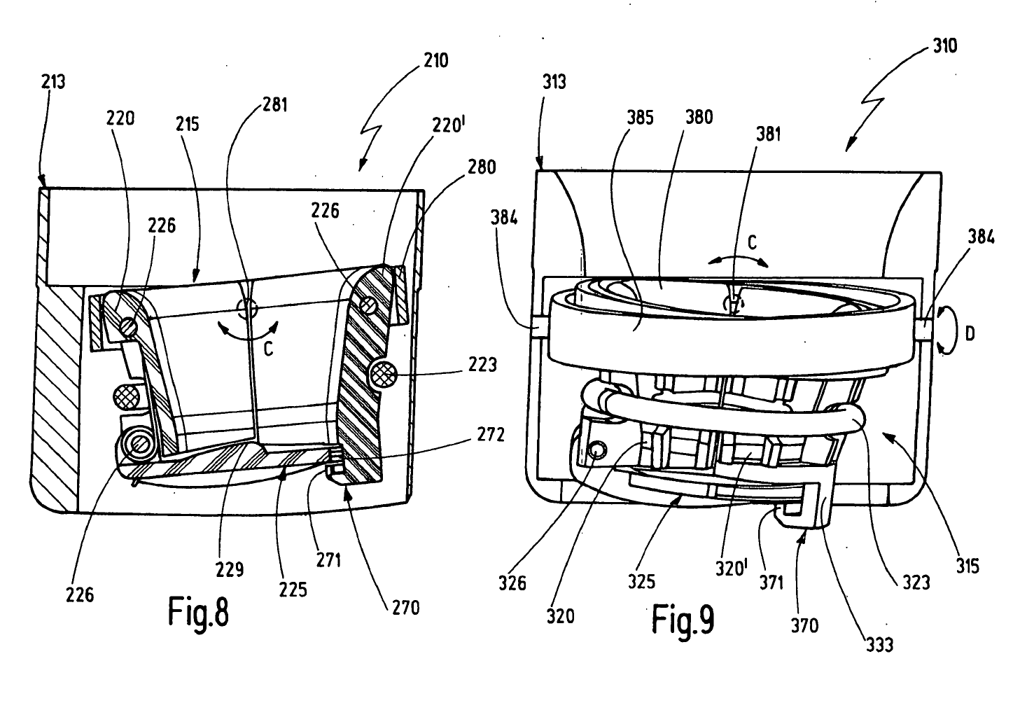

FIG. 8 depicts a representation corresponding to FIG. 2 and FIG. 5 through a incorrect-refueling device for a tank filler tube according to a third exemplary embodiment of the present invention, and

FIG. 9 depicts a partial perspective side view of an incorrect-refueling device for a tank filler tube according to a fourth exemplary embodiment of the present invention.

Incorrect-refueling device 10, 110, 210, 310, as depicted in the drawing, is configured in the depicted exemplary embodiments as an insert 11, 111, 211, 311, for an undepicted filler tube of an undepicted tank, for example an automobile tank. The essential parts of incorrect-refueling device 10, 110, 210, 310 are made of plastic, by way of example.

Incorrect-refueling device 10 in accordance with FIGS. 1 to 4 has a jacket 13 made of plastic, which at its access side and has two bayonet lock projections 12, diametrically opposite each other, and which can be inserted into a filler tube and fixed in an appropriate manner. Molded within jacket 13 is an eccentric, open interior ring 14, within which a receiving element 15 is supported for discharge tube 18 of a pump nozzle 17 (FIGS. 3 and 4) for diesel fuel, for example.

Receiving element 15, which can be pressed apart by discharge tube 18 of pump nozzle 17, in the depicted exemplary embodiment has two circumferential wall parts 20, 20′, which in a top view (FIG. 1A) are configured as semi-oval or semi-ellipsoid and which are hinged so as to be able to radially pivot (double arrow A and A′) about a horizontal pivot axis 21, 21′, respectively, on parallel pairs of bars 31, 32 that protrude on both sides from the interior circumference of jacket 13. In this context, due to the eccentric arrangement, bars 31 are wider than bars 32. The pairs of bars running axially in jacket 13 also act as an axial guide for circumferential wall parts 20, 20′, which contact each other when they are inserted into jacket 13. The long axis of the oval, or of the ellipse, extends parallel to pivot axes 21, 21′ and therefore diagonal to pivot direction A, A′. Circumferential wall parts 20, 20′, two in number by way of example, are radially biased against each other by a spring-action annular element 23 that is inserted into an exterior circumferential groove 22, for example a rubber- or O-ring. The upper, bead-shaped edges, situated toward the outside, of both circumferential wall parts 20, 20′ are each formed so as to be wedge-shaped in order to facilitate the radial pivoting characteristic of circumferential wall parts 20, 20′ for releasing flap 25. Circumferential wall parts 20, 20′, as is also indicated by FIG. 2, are shaped so that, on both lateral areas of the short axis, an interior space 24 is generated that tapers from top (input side) to bottom (output side). The access side of this interior space 24 has clearance cross-sectional dimensions which in the area of the long axis are greater than, and in the area of the short axis are equal to, the exterior circumference of discharge tube 18 of designated pump nozzle 17. The output side of interior space 24, on the other hand, in the area of the short axis has smaller clearance cross-sectional dimensions.

Incorrect-refueling device 10 also has a roughly circular flap 25, which in the initial position according to partial FIGS. 1A and 1B and in FIG. 2 represents an output-side cover of interior space 24 of receiving element 15. For this purpose, flap 25 is hinged via a plate on one of its exterior circumferential areas so as to be able to pivot by means of a hinge axis 26 on bars that protrude on the exterior side of one circumferential wall part 20. One circumferential area 27 of flap 25, which is diametrically opposite this hinge axis 26, is configured as a locking end and is held in a form-locking manner in an interior circumferential groove 28 of a lower, i.e., output-side extension 33 of the other circumferential wall part 20′, diametrically opposite. Bead-shaped extension 33 is significantly narrower than circumferential wall part 20′.

The form-locking joining of flap 25 and extension 33 of the relevant circumferential wall part 20′ is accomplished only via a partial area of the semicircular circumferential edge of flap 25, so that no output-side sealing of interior space 24 of receiving element 15 results. Flap 25 also has on its interior surface a longitudinal curvature 29, which extends from the pivot end to the latching end of flap 25 and acts as a kind of cam surface with respect to discharge tube 18 of pump nozzle 17.

If a pump nozzle for gasoline, for example, is inserted into receiving element 15, then incorrect-refueling device 10 and its flap 25 remain in the locked position because the exterior diameter of the discharge tube of a gasoline pump nozzle is smaller than that of discharge tube 18 of a diesel pump nozzle and therefore is equal to or smaller than the minimal clearance width of interior space 24 in the area in front of flap 25.

FIGS. 3 and 4 show the unlocking, or opening of flap 25 from, or opposite, the relevant circumferential wall parts 20′, 20 if a pump nozzle 17, in this case for diesel fuel, is inserted into receiving element 15, its discharge tube 18 in front.

Due to the large exterior diameter of discharge tube 18, which matches interior space 24, both circumferential wall parts 20, 20′ are continuously pressed apart in the radial direction (arrow A,A′) so that, as indicated in FIG. 3, locking edge 27 of flap 25 is released from locking transverse groove 28 of relevant circumferential wall part 20′.

As discharge tube 18 of pump nozzle 17 continues to be inserted and pushed through into and through receiving element 15, flap 25 is opened in the direction of the arrow B, so that the outlet of interior space 25 is released for the penetration of the discharge end of pump nozzle tube 18.

When pump nozzle 17 is withdrawn, there is initially a return of flap 25 to its initial position due to spring-acting pivot axis 26, and flap 25 locks in latching groove 28 of relevant circumferential wall part 20′ due to spring ring 23, which acts in the radial direction upon circumferential wall parts 20, 20′.

When both circumferential wall parts 20, 20′ are pressed apart, the latter at their output-side end encounter a limit stop at jacket 13, which surrounds them, only limit stop 34 being depicted for circumferential wall part 20′. This results in a radial limitation of the pivoting motion of both circumferential wall parts 20, 20′ such that each quantity of motion is less than the depth of latching groove 28. This is intended to prevent the motion of only one circumferential wall part 20, 20′ from resulting in an unlocking of flap 25 due to the false positioning of pump nozzle tube 18.

In place of a spring ring 23 around both circumferential wall parts 20, 20′, circumferential wall parts 20, 20′ can each be constituted by one or more coil springs, which are distributed over the exterior circumference, exert a radial effect, and are supported on the interior side of jacket 13. Springs that operate similarly may also be wrapped around pivot axes 21 and hinge axes 26 of flap 25.

In place of two circumferential wall parts 20, 20′, it is also possible to provide a total of four circumferential wall parts for the receiving element. In place of the tapering of circumferential wall parts of various cross-sections, the latter can be provided with a uniform cross-section and contact chamfers on opposite areas.

Incorrect-refueling device 110, depicted in FIGS. 5 to 7 in accordance with a second exemplary embodiment, is essentially designed in form and function in accordance with incorrect-refueling device 10 as depicted in FIGS. 1 to 4. Therefore, essentially only the differences in individual components of incorrect-refueling device 110 are described, in comparison to the corresponding components of incorrect-refueling device 10.

Incorrect-refueling device 110 essentially has four additional form and function features, which individually or in combination are designed to prevent the opening of flap 125 as a result of the intentional or unintentional manipulative operation using an incorrect pump nozzle 17 (one for gasoline).

For this purpose, incorrect-refueling device 110 has: first, a device 140 (FIG. 5), which is designed to prevent an axial shifting of both circumferential wall parts 120, 120′, which contact each other; second, a device 150 (FIG. 6), which is designed to prevent a radial motion apart of both circumferential wall parts 120, 120′ by an incorrect pump nozzle 17; third, a device 160 (FIG. 7), which is designed to prevent a lateral pressing of both circumferential wall parts 120, 120′ against each other and therefore a lateral pressing of flap 125 at the side of flap 125 that is facing away from pivot axis 126 within circumferential wall part 120′, which it is in contact with; and fourth, a device 170 (FIG. 5), which acts to prevent an opening of flap 125 in the direction of arrow B if flap 125 is somewhat pivoted by an incorrect pump nozzle in the direction of arrow B within interior circumferential groove 128, and to retrieve the flap from this locking position by pressing apart both circumferential wall parts 120, 120′.

First device 140 in accordance with FIG. 5 has a circumferential-side nib 143 on longitudinal edges 141, 142, which contact each other, of both end areas of circumferential wall parts 120, 120′, said nib engaging in a circumferential-side recess 144 and thus preventing an axial shifting of both circumferential wall parts 120, 120′ with respect to each other. The length of nib 143 and the depth of recess 144, which are roughly equal, are such that when circumferential wall parts 120, 120′ are pressed apart (corresponding to the positions in FIG. 4), nibs 143 continue to partially engage in recesses 144, so that an axial shifting of both circumferential wall parts 120, 120′ is also prevented in this filling position.

Second device 150 in accordance with FIG. 6 has a protruding hook 151 on a circumferential area of one of both circumferential wall parts 120, 120′, in the vicinity of a longitudinal edge 141, 142 of the relevant circumferential wall part, here circumferential wall part 120′, said hook with its hook end 153 engaging with a bar 152 that runs along the other longitudinal edge 142 of other circumferential wall part 120. Hook 151 is situated in the vicinity of exterior circumferential groove 122, in which ring spring 123 is arranged. Hook 151 overlaps bar 152 with radial and circumferential play.

In third device 160 in accordance with FIG. 7, flap 125 has a radial slot 161 that is introduced in an area of its circumference, and axial extension 133 of circumferential wall part 120′ has a finger 142, which radially protrudes as an integral part from an interior area of axial extension 133 and engages in slot 161. In this way, in the closed initial position of flap 125 according to FIG. 5, a diagonal shifting of flap 125 with respect to circumferential wall part 120′ is prevented.

In accordance with FIG. 5, fourth device 170 at its axial extension 133, which is somewhat longer, thus causing a widening of interior circumferential groove 128, has a bar 171 that is curved in the longitudinal direction at its free end, faces the interior, and axially points to the lower side of flap 125, which in this area has an arc-segment-shaped groove 172 that emerges from the lower side. Therefore, if flap 125 is moved in the direction of arrow B by an incorrect pump nozzle 17, bar 171 of axial extension 133 engages in groove 172 of flap 175, which prevents both circumferential wall parts 120, 120′ from executing a radial or pivot-like motion apart, or flap 125 from releasing from interior circumferential groove 128 by manipulation.

A further modification of incorrect-refueling device 110, in contrast to device 10, relates to longitudinal curvature 129 on the interior side of flap 125, which in this exemplary embodiment only runs through an area facing pivot axis 126, in other words through roughly half of the diameter area.

As it was depicted with respect to the exemplary embodiments of incorrect-refueling device 10, 110, within insert 11, 111, receiving element 15, 115, which is furnished with circumferential wall parts 20, 20′ or 120, 120′ and flap 25, 125, is arranged within jacket 13, 113, which is made of plastic, so as to be rigid or so as to be fixed through guidance by pairs of bars 31, 32, 131, 132.

In incorrect-refueling device 210, on the other hand, both circumferential wall parts 220, 220′, which are equipped with flap 225, are attached to a support ring 280 via pivot axes 226 so as to be able to pivot (FIG. 8). Support ring 280, indicated by dashed lines, is held on two pivot pins 281 that are arranged diametrically opposite each other and are offset by 90° with respect to both pivot axes 226, but are arranged in the same radial direction, parallel to said pivot axes, in a manner that is not depicted in detail within plastic jacket 213, so as to be able to pivot in the direction of double arrow C. In other words, support ring 280, along with both circumferential wall parts 220, 220′ and circular flap 225, is suspended within jacket 213 in semi-gimbal fashion, so to speak. Thus, a manipulation of receiving element 215 by an incorrect pump nozzle 17 is prevented in another way because, in response to a manipulation of this type, receiving element 215 can evade it due to its semi-gimbal-type suspension within jacket 213.

FIG. 9 depicts a design of an incorrect-refueling device 310, in which a (full) gimbal-mounted suspension is accomplished with two degrees of freedom of receiving element 315, which otherwise corresponds to the design of receiving element 215 and 115. For this purpose, support ring 380, within which receiving element 315 is suspended so as to be able to pivot in the direction of double arrow C, is surrounded by another support ring 385, in which support ring 380 is supported so as to be able to pivot in the direction of double arrow D, which direction is rotated by 90° with respect to direction C. Support ring 385 is connected to sleeve 313 via pivot pins 384 so as to be able to pivot. Thus receiving element 315 is held so as to be able to pivot, in accordance with a gimbal-mounted suspension, to all “points of the compass.”

It goes without saying that both incorrect-refueling devices 210 and 310 can be equipped with a receiving element 15 in accordance with FIGS. 1 to 4. In addition, a receiving element 115 can be used that can have one or more or all of additional devices 140 and/or 150 and/or 160 and/or 170.

In the exemplary embodiments depicted, incorrect-refueling device 10, 110, 210, 310 is described as an insert 11, 111, 211, 311 for a tank filler tube. It is obvious that incorrect-refueling device 10, 110, 210, 310 can also be a component part of a tank filler tube, that therefore the tank filler tube is designed in the filler area so that it directly contains incorrect-refueling device 10, 110, 210, 310 in the form of receiving element 15, 115, 215, 315 having flap 25, 125, 225, 325.

The same also applies to a tank that is designed as or provided with a filler tube, in the form, for example, of a tank that is equipped either with an insert of this type 11, 111, 211, 311 for the filler tube or with a filler tube that is provided with incorrect-refueling device 10, 110, 210, 310.

It remains to be mentioned that in an incorrect-refueling system, the design of the discharge end of discharge tube 18, 118 of pump nozzle 17, 117, on the one hand, and the design of the interior surface of flap 25, 125, 225, 325, on the other hand, can be coordinated with each other, as is done, for example, by a shaping 29, 129 of the interior surface of flap 25, 125, 225, 325.

In any case, the length and/or the angle of the taper of circumferential wall parts 20, 20′, 120, 120′, 220, 220′, 320, 320′, or the conicity of the contact chamfers can be dimensioned so that even when pump nozzle 17 is withdrawn very rapidly from the tank filler tube or its insert, flap 25, 125, 225, 325 can return to its initial position before the two circumferential wall parts are moved towards each other and lock the flap.

1-27. (canceled)

28. An incorrect-refueling device for a filler tube of a tank, comprising:
a receiving element, which can be pressed apart radially from its interior space at least on opposite wall areas, said receiving element defining an input side and an output side; and a flap, which is arranged on the output side of said receiving element, covers the receiving element in locking fashion in a resting state, and is unlocked and can be opened under pressure when said receiving element is pressed apart.

29. The incorrect-refueling device as recited in claim 28, wherein:
said receiving element has an interior space that narrows from said input to said output.

30. The incorrect-refueling device as recited in claim 28, wherein:
said receiving element in cross-section is one of:
oval, elliptical, sleeve-shaped, and polygonal.

31. The incorrect-refueling device as recited in claim 28, wherein:
said receiving element can be elastically pressed apart.

32. The incorrect-refueling device as recited in claim 28, wherein:
said receiving element includes individual circumferential wall parts that are arranged so as to be preferably uniformly distributed over the circumference, and that are hinged at their said input-side.

33. The incorrect-refueling device as recited in claim 32, further comprising:
a jacket that surrounds said receiving element, wherein:
said circumferential wall parts of said receiving element are directly or indirectly hinged on said jacket.

34. The incorrect-refueling device as recited in claim 32, wherein:
said circumferential wall parts can be pressed apart in opposition to the action of said spring device.

35. The incorrect-refueling device as recited in claim 34, wherein:
said spring device is formed by an elastic ring, or the like.

36. The incorrect-refueling device as recited in claim 32, wherein:
said preferably two circumferential wall parts, on their side edges that contact each other, have an axial shift guard.

37. The incorrect-refueling device as recited in claim 36, wherein:
said axial shift guard is formed by a nib on one circumferential wall part that engages in a recess on the other circumferential wall part.

38. The incorrect-refueling device as recited in claim 32, wherein:
said preferably two circumferential wall parts are provided with an exterior-circumferential-side locking device in the area of their side edges, bordering each other, to prevent the circumferential wall parts from pressing against each other in the initial state.

39. The incorrect-refueling device as recited in claim 38, wherein:
said exterior-circumferential-side locking device on one circumferential wall part has a roughly U-shaped hook, which overlaps an axial exterior bar on the other circumferential wall part with play.

40. The incorrect-refueling device as recited in claim 32, wherein:
said flap is hinged on the output-side end of one of said circumferential wall parts, and on said other circumferential wall part diametrically opposite said circumferential wall part, a pivot locking device and/or a transverse locking device is provided at the free end of said flap that is facing away from the hinge.

41. The incorrect-refueling device as recited in claim 40, wherein:
said flap is hinged so as to be axially subject to a spring force.

42. The incorrect-refueling device as recited in claim 40, wherein:
a free end of said flap engages in a radially open groove of the relevant part of said circumferential wall part in a form-locking manner.

43. The incorrect-refueling device as recited in claim 42, wherein:
said radially open groove has a hook pointing towards said flap, and opposite this, said flap has a groove that is preferably distanced in the resting position.

44. The incorrect-refueling device as recited in claim 42, wherein:
said free end of said flap has a radially open slot, in which in the resting position a radial finger engages, which is arranged in said radially open groove.

45. The incorrect-refueling device as recited in claim 40, wherein:
said flap at its axially aligned interior side is provided with a cam surface.

46. The incorrect-refueling device as recited in claim 28, wherein:
a limit stop that limits the pivot motion is assigned to said circumferential wall parts, which can be pressed apart.

47. The incorrect-refueling device as recited in claim 32, wherein:
said receiving element or its circumferential wall parts are suspended on a jacket by a support ring so as to be able to pivot.

48. The incorrect-refueling device as recited in claim 28, wherein:
said receiving element or its circumferential wall parts are suspended on a jacket by two support rings so as to be able to move in gimbal-mount fashion.

49. A filler tube for a tank having an incorrect-refueling device comprising:
a receiving element, which can be pressed apart radially from its interior space at least on opposite wall areas, said receiving element defining an input side and an output side; and a flap, which is arranged on the output side of said receiving element, covers the receiving element in locking fashion in a resting state, and is unlocked and can be opened under pressure when said receiving element is pressed apart.

50. The filler tube as recited in claim 49, wherein:
the incorrect-refueling device is configured as an insert for the filler tube.

51. The filler tube as recited in claim 50, wherein:
said insert is formed by a piece of a jacket in which said receiving element and said flap are supported.

52. The filler tube as recited in claim 49, wherein:
the arrangement of the receiving element and the flap directly in the filler tube.

53. A liquid tank having a filler tube comprising:
a receiving element, which can be pressed apart radially from its interior space at least on opposite wall areas, said receiving element defining an input side and an output side; and a flap, which is arranged on the output side of said receiving element, covers the receiving element in locking fashion in a resting state, and is unlocked and can be opened under pressure when said receiving element is pressed apart.

54. An incorrect-refueling system, having an incorrect-refueling device as recited in claim 28 and having a pump nozzle, whose discharge tube has an exterior diameter that is greater than the minimal interior dimensions of the receiving element of the incorrect-refueling system.
